(19) United States
(12) Patent Application Publication
(10) Pub. No.: US 2017/0348962 A1
(43) Pub. Date: Dec. 7, 2017

(54) SCREEN PLATE AND MAUFACTURING METHOD THEREOF

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventor: Ang XIAO, Beijing (CN)

(21) Appl. No.: 15/504,101

(22) PCT Filed: Jul. 11, 2016
(86) PCT No.: PCT/CN2016/089614

§ 371 Date: Aug. 21, 2017

(30) Foreign Application Priority Data
Oct. 10, 2015 (CN) 201510654266.2

(51) Int. Cl. B41F 15/36; B41C 1/14

(52) U.S. Cl. CPC B41F 15/36; B41C 1/14

(57) ABSTRACT

A screen plate and a manufacturing method of the screen plate, provided for solving a problem of glass cement being thicker at the center and thinner at the border during printing glass cement by use of the screen plate in the prior arts and an inclination of burr generated at the borders. In the screen plate, a pattern layer comprises a plurality of openings, each of which comprises at least two sub-openings which have horizontal dimensions gradually decreasing in a vertical direction from a side close to the screen to a side away from the screen, so that a blade can squeeze the glass cement through a region of the screen corresponding to the sub-opening closest to the screen and further squeeze the glass cement through the plurality of the sub-openings having gradually reduced horizontal dimensions, thereby achieving a uniform output amount of the glass cement at the sub-opening farthest from the screen and eliminating the burr at the border of the printed pattern of the glass cement.

### TECHNICAL FIELD

The present invention relates to display technology field, and more particularly to a screen plate and a manufacturing method thereof.

### BACKGROUND

An organic electroluminescent display (OLED) device is a display device that emits light initiatively through driving illuminant materials by an electric current. The illuminant materials commonly used in OLED devices comprise dyes and pigments of small molecules, which are very sensitive to water and oxygen and will lose their luminous characteristics soon after being exposed to water and oxygen. Thus, a good sealing environment is very important for the life of OLED devices. Glass cement becomes commonly-used material in the existing packaging technology due to its high mechanical strength and low water and oxygen permeability after being cured.

Packaging of illuminant materials by glass cement (i.e., patterning of glass cement) is achieved through screen printing technology. FIG. 1 shows, in sectional view, a structure of a screen plate used in a screen printing process in the prior art. As shown in FIG. 1, glass cement 4 is applied onto a side of the screen 1 and emulsion is usually used to form a pattern on the screen 1 by patterning process. Specifically, the emulsion is firstly applied onto a side of the screen 1 opposite to the glass cement 4 and then is exposed to light by use of a corresponding mask (not shown). A pattern layer 2 is formed after developing and the pattern layer 2 comprises an opening 3 corresponding to a pattern to be printed. It should be understood that the emulsion can infiltrate into the screen 1 and the emulsion in the screen 1 at the portion corresponding to the opening 3 is removed during the developing, while the emulsion in the screen 1 at the remaining portions is retained. Thus, the portion of the screen 1 corresponding to the opening 3 forms a passage 7 through which the glass cement 4 can penetrate.

When the glass cement 4 is uniformly applied onto a side of the screen 1 opposite to the pattern layer 2, a blade is horizontally moved on a side of the screen 1 applied with the glass cement 4 in a manner of applying a certain pressure to the screen 1 so as to force the glass cement 4 to pass through the passage 7 within the screen 1 and seep out of the opening 3, thereby carrying out the printing.

The inventors of the present application have found in experiments that a seepage of the glass cement 4 at the border of the opening 3 is less than a seepage of the glass cement 4 at the center of the opening 3, which results in two problems as below:

1. the glass cement 4 is formed like a single peak on the substrate; as shown in FIG. 2, the glass cement 4 at the center of the opening 3 is thick, while the thickness of the glass cement 4 is gradually reduced from the center to the border, which adversely affects the sealing effect;

2. at the border of the glass cement 4, as shown in FIG. 3, a burr 8 of the glass cement 4 is inclined to be formed due to a smaller amount of the fall-down glass cement.

### SUMMARY

A screen plate and a manufacturing method thereof are provided to solve the technical problem mentioned above.

The present invention provides a screen plate, which comprises a screen and a pattern layer on a side of the screen, the pattern layer comprising at least one opening configured to form a pattern; the opening having a horizontal dimension which gradually decreases in a vertical direction from a side close to the screen to a side away from the screen.

Optionally, the opening comprises at least two sub-openings, and the respective sub-openings have horizontal dimensions gradually decreasing in turn along the vertical direction from the side close to the screen to the side away from the screen.

Optionally, orthographic projections of center lines of the sub-openings on the screen coincide with each other.

Optionally, differences in the horizontal dimensions of the sub-openings which are adjacent to each other in the vertical direction are equal.

Optionally, a difference between the horizontal dimension of the sub-opening closest to the screen and the horizontal dimension of the sub-opening farthest away from the screen is 50-200 um.

Optionally, a thickness of the sub-opening farthest away from the screen in a direction perpendicular to the screen is 2-10 um.

Optionally, the thickness of the sub-opening farthest away from the screen in the direction perpendicular to the screen is 4-7 um.

According to another purpose of the present invention, a manufacturing method of a screen plate is provided, comprising steps of:

applying a photoresist on a side of a screen;

exposing the side of the screen applied with the photoresist to light, forming a pattern of a sub-opening farthest away from the screen by developing, and then, exposing and developing at least once at a side of the screen opposite to the side applied with the photoresist so as to form at least one sub-opening; wherein the thus-formed sub-opening has a horizontal dimension gradually decreasing in turn in a vertical direction from a side close to the screen to a side away from the screen; or,

exposing and developing at least twice at a side of the screen opposite to the side applied with the photoresist, so as to form at least two sub-openings; wherein the thus-formed sub-openings have horizontal dimensions gradually decreasing in turn in a vertical direction from a side close to the screen to a side away from the screen.

Optionally, positions of the respective mask plates used during exposure are controlled so that orthographic projections of center lines of the sub-opening patterns, which correspond to the respective mask plates, on the screen coincide with each other.

Optionally, sizes of the respective mask plates used during exposure are controlled so that differences in the horizontal dimensions of the adjacent sub-opening patterns among the respective sub-opening patterns which correspond to the respective mask plates are equal.

Optionally, sizes of the respective mask plates used during exposure are controlled so that a difference between the horizontal dimension of the sub-opening pattern closest to the screen 1 and the horizontal dimension of the sub-opening pattern farthest away from the screen 1 is 50-200 um.

In the screen plate and the manufacturing method thereof according to the present invention, the pattern layer comprises a plurality of openings configured to form a pattern of an object to be coated (for example, glass cement), the openings respectively comprises at least two sub-openings having horizontal dimensions gradually decreasing in the vertical direction from a side close to the screen to a side away from the screen. Therefore, the blade can squeeze the glass cement on a region of the screen corresponding to the sub-opening closest to the screen and further squeeze the glass cement through the plurality of the sub-openings having gradually reduced horizontal dimensions, thereby achieving a uniform cement amount at the sub-opening farthest away from the screen and overcoming the burr defect at the border of the printed pattern of the glass cement.

### BRIEF DESCRIPTION OF THE DRAWINGS

FIG. 1 is an illustrative structural view of a screen plate in the screen printing process according to prior arts;

FIG. 2 is an illustrative cross-sectional view of the glass cement in the screen printing process according to prior arts;

FIG. 3 is a photograph of the glass cement after the screen printing process according to prior arts;

FIG. 4 is an illustrative structural view of a screen plate according to a first embodiment of the present invention;

FIG. 5 is an illustrative cross-sectional view of glass cement according to the first embodiment of the present invention;

FIG. 6 is a photograph of the glass cement after screen printing according to the first embodiment of the present invention;

FIG. 7 is an illustrative structural view of the screen plate applied with emulsion according to a second embodiment of the present invention;

FIG. 8 is an illustrative view of a first exposing and developing process in the manufacturing method according to the second embodiment of the present invention;

FIG. 9 is an illustrative view of a second exposing and developing process in the manufacturing method according to the second embodiment of the present invention;

FIG. 10 is an illustrative view of a third exposing and developing process in the manufacturing method according to the second embodiment of the present invention;

FIG. 11 is an illustrative view of a fourth exposing and developing process in the manufacturing method according to the second embodiment of the present invention;

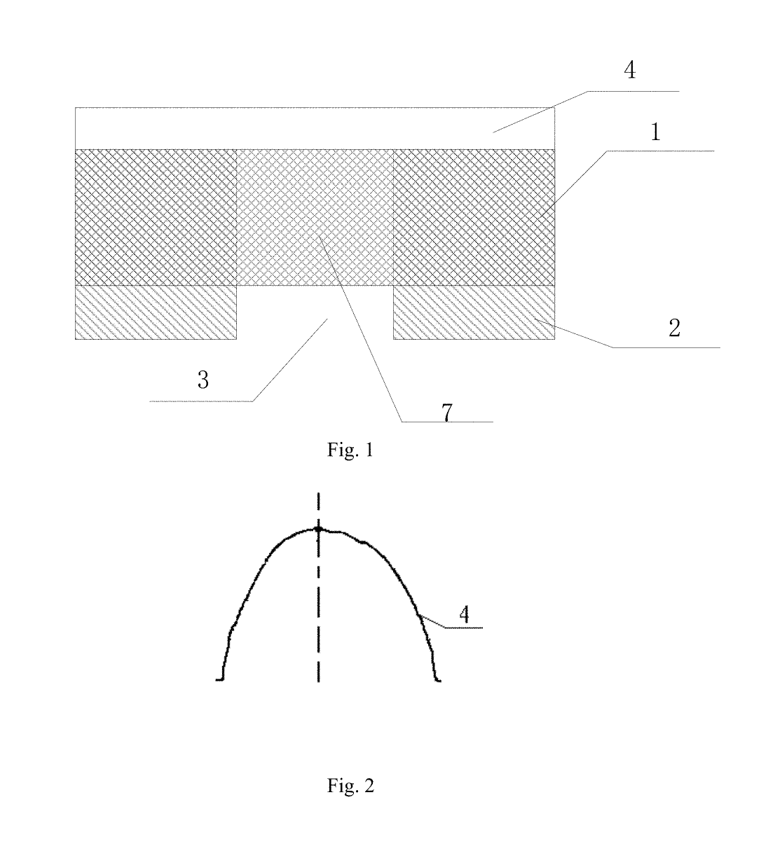

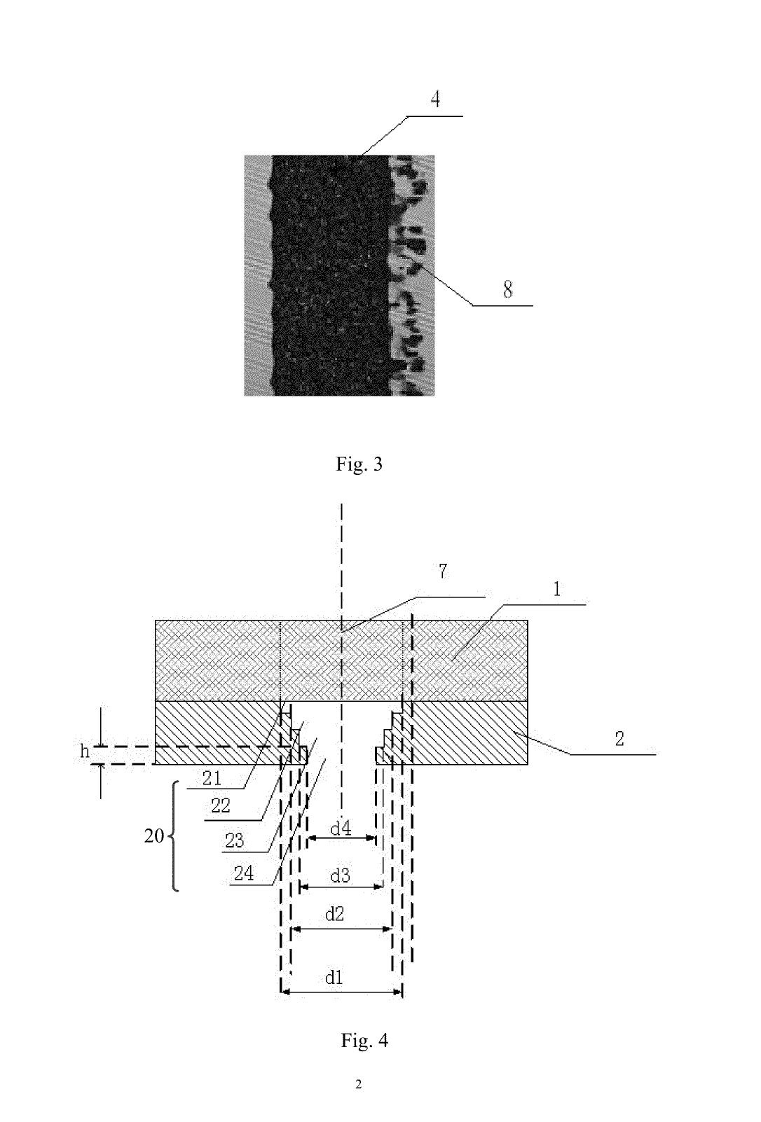

wherein the reference numerals are: 1. screen; 2. pattern layer; 20. opening; 21. first sub-opening; 22. second sub-opening; 23. third sub-opening; 24. fourth sub-opening; 3. opening; 4. glass cement; 5. mask plate; 6. exposure light; 7. passage; 8. burr; 9. emulsion;

h: the thickness of the fourth sub-opening in a direction perpendicular to the screen;

d1: the width of the first sub-opening;

d2: the width of the second sub-opening;

d3: the width of the third sub-opening; and

d4: the width of the fourth sub-opening.

### DETAILED DESCRIPTION

In order that those skilled in the art could better understand the technical solution of the present invention, the invention will be described in further detail below with reference to the accompanying drawings and specific embodiments.

### The First Embodiment

As illustrated in FIG. 4, the present embodiment provides a screen plate comprising a screen 1 and a pattern layer 2 disposed on a side of the screen 1. The pattern layer 2 comprises at least one opening 20 configured to form a pattern of an object to be coated (for example, a glass cement). The opening 20 has a horizontal dimension which gradually decreases in a vertical direction from a side close to the screen to a side away from the screen. Substance to be printed penetrates the pattern layer 2 from a side of the screen opposite to the pattern layer 2, so as to implement printing.

The opening 20 comprises at least two sub-openings, each of which has a horizontal dimension gradually decreasing in the vertical direction from a side close to the screen to a side away from the screen. For example, as illustrated in FIG. 4, the opening 20 comprises a first sub-opening 21, a second sub-opening 22, a third sub-opening 23 and a fourth sub-opening 24 arranged in order from a side close to the screen 1 to a side away from the screen 1. The widths of the first sub-opening 21, the second sub-opening 22, the third sub-opening 23 and the fourth sub-opening 24 are d1, d2, d3 and d4, respectively. It should be understood that the pattern of the object to be coated is formed as hollow regions. Each pattern layer 2 comprises at least one opening 20, the shape of which is varied according to variation of the pattern. Here, the width refers to the horizontal dimension of an opening of the pattern layer at the cross section.

In the screen plate according to the present embodiment, the pattern layer 2 comprises at least one opening 20 configured to form a pattern of an object to be coated (for example, a glass cement). The opening 20 comprises four sub-openings 21, 22, 23 and 24 having horizontal dimensions gradually decreasing in the vertical direction from a side close to the screen 1 to a side away from the screen 1. Therefore, the blade can squeeze the glass cement on a region of the screen 1 corresponding to the sub-opening closest to the screen 1 and further squeeze the glass cement through the plurality of the sub-openings having gradually reduced horizontal dimensions, thereby achieving a uniform cement amount at the sub-opening farthest away from the screen 1 and overcoming the burr defect at the border of the printed pattern of the glass cement.

Optionally, orthographic projections of center lines of the sub-openings on the screen 1 coincide with each other. Therefore, the glass cement 4 is uniformly squeezed from both borders towards the center of the sub-opening, thereby avoiding a phenomenon of more glass cement on one border and less glass cement on the other border.

Optionally, differences in the horizontal dimensions of adjacent sub-openings are equal. Thus, the glass cements flowing downwards from both borders of the sub-openings are subjected to the same resistance, thereby maintaining a uniform downward movement of the glass cement.

Optionally, a difference between the horizontal dimension of the sub-opening (for example, the first sub-opening 21) closest to the screen 1 and the horizontal dimension of the sub-opening (for example, the fourth sub-opening 24) farthest away from the screen 1 is 50-200 um. As illustrated in FIG. 4, the difference between d1 and d4 is in the range of 50-200 um, thereby ensuring that a sufficient amount of glass cement uniformly flows out of the fourth sub-opening 24.

Optionally, the sub-opening (for example, the fourth sub-opening 24) farthest away from the screen 1 has a thickness h in a direction perpendicular to the screen 1 and the thickness h is 2-10 um. Since the fourth sub-opening 24 is subjected to frequent impacts by the glass cement during the printing process and is inclined to be damaged or deformed, the thickness h not only can help the fourth sub-opening 24 reach a certain strength but also can solve the burr problem, thereby ensuring its service life and effect.

Optionally, the thickness of the sub-opening (for example, the fourth sub-opening 24) farthest away from the screen 1 in the direction perpendicular to the screen 1 is in a range of 4-7 um. Such a range can ensure the service life and effect, while ensuring that no excessive glass cement is retained.

It should be understood that there are at least two or more sub-openings. The present embodiment is described by taking four stepped openings as an example which cannot be construed as a restriction to the present invention. Further, the present embodiment is described by taking glass cement as an example of the object to be coated, but the present invention is not restricted thereto. The object to be coated on the screen can be varied according to various purposes.

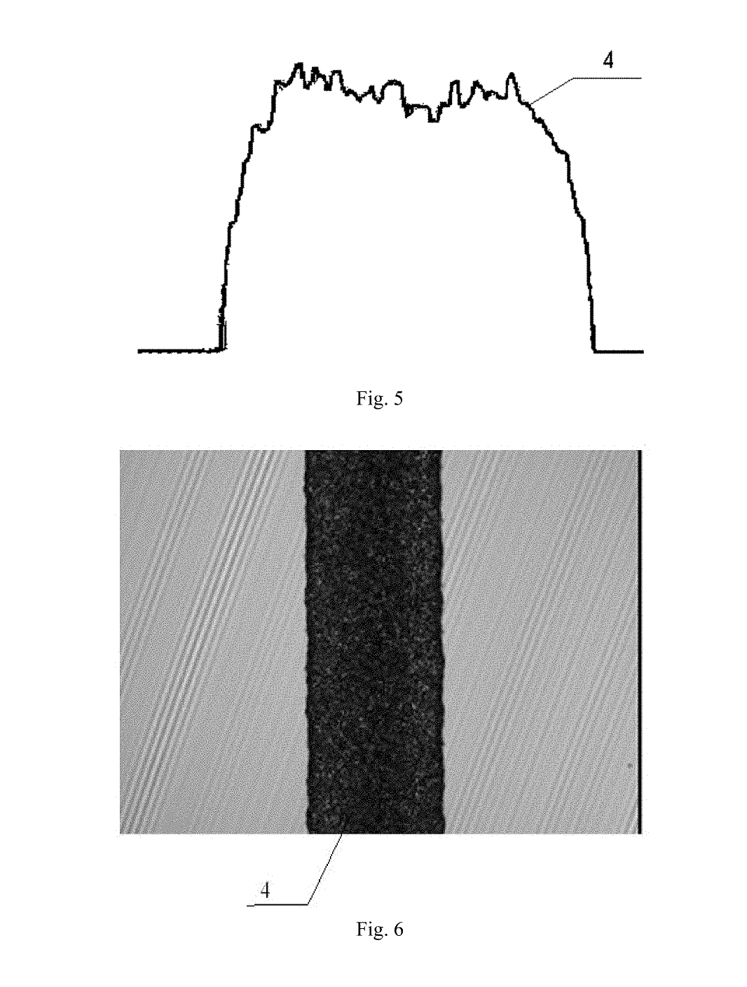

FIG. 5 illustrates a cross-sectional view of the glass cement 4 formed after printing the glass cement by use of the screen plate according to the present embodiment. The glass cement 4 has substantially the same heights at the center and at the border, thereby avoiding a single-peaked glass cement formed by printing by use of the screen plate of prior arts. And at the same time, as illustrated in FIG. 6, there is no burr at the border of the glass cement 4.

### The Second Embodiment

The present embodiment provides a manufacturing method of a screen plate, comprising the following steps:

applying a photoresist on a side of a screen;

exposing the side of the screen applied with the photoresist to light, forming a pattern of the sub-opening farthest away from the screen by developing, exposing and developing at least once at a side of the screen opposite to the side applied with the photoresist, and forming at least one sub-opening; wherein the thus-formed sub-openings have a horizontal dimension gradually decreasing in a vertical direction from a side close to the screen to a side away from the screen;

or,

exposing and developing at least twice at a side of the screen opposite to the side applied with the photoresist, and forming at least two sub-openings; wherein the thus-formed sub-openings have horizontal dimensions gradually decreasing in a vertical direction from a side close to the screen to a side away from the screen.

Specifically, the method comprises the steps S1 to S3.

In S1, applying a photoresist on a side of a screen.

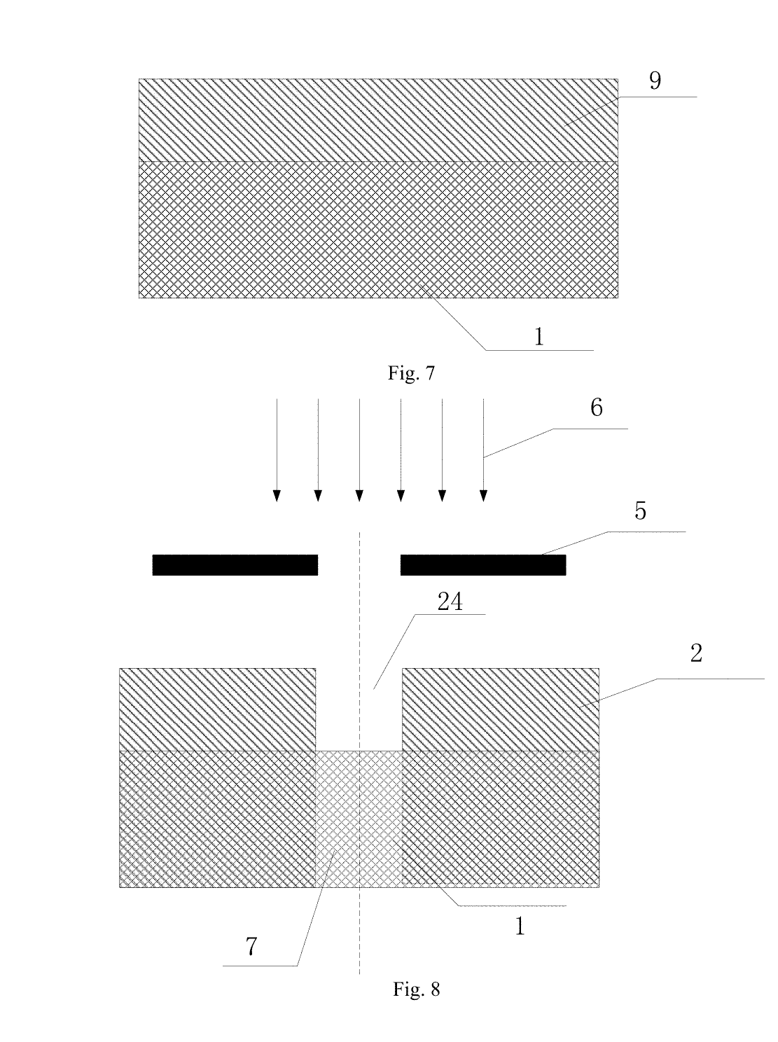

As illustrated in FIG. 7, a side of the screen 1 is applied with emulsion 9. It should be understood that the emulsion 9 can infiltrate into the entire screen 1.

In S2, the side of the screen applied with the photoresist is exposed to light and developed, thereby forming a pattern of the sub-opening farthest away from the screen.

As illustrated in FIG. 8, a mask plate 5, which is corresponding to the fourth sub-opening 24 to be formed, is disposed between the exposure light 6 and the side of the screen 1 applied with the emulsion 9. It should be understood that the above-described mask plate 5 corresponds to the entire pattern to be printed, and an example of the fourth sub-opening 24 as a part of the entire pattern to be printed is exemplified to describe the specific forming process of all the patterns.

As illustrated in FIG. 8, a pattern layer 2 can be formed at the outer side of the screen 1 after exposing and developing. The pattern layer 2 comprises the fourth sub-opening 24. As for the emulsion 9 infiltrating into the screen 1, the irradiated part of the emulsion 9 is removed by developing and forms a passage 7 within the screen 1, while other part of the emulsion 9 is retained.

A positive photoresist (for example, RZJ-304) is used as the emulsion 9 in the present embodiment. It should be understood that a negative photoresist (SUN-120N) can be used as well, in this case the pattern of the mask plate 5 used during exposing process is changed correspondingly (opening area and blocking area are interchanged).

It should be understood that above-described exposing and developing are the same as those in the prior arts and will not be described in further detail. And at the same time, the size of the above-described pattern layer 2 can be precisely controlled by the corresponding mask plate 5. In other words, the size of the fourth sub-opening 24 can be controlled.

In S3, exposing and developing are performed at least once at the side of the screen opposite to the side applied with the photoresist, thereby forming at least one sub-opening; wherein the respective sub-opening has a horizontal dimension gradually decreasing in a vertical direction from a side close to the screen to a side away from the screen.

Specifically, the step S3 can comprise the following sub-steps S31 to S33.

In S31, the third sub-opening is formed.

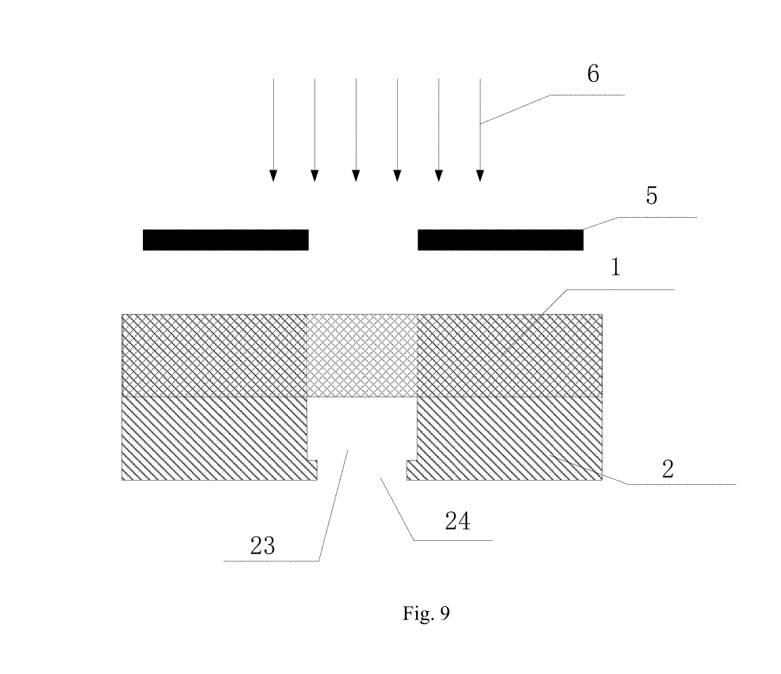

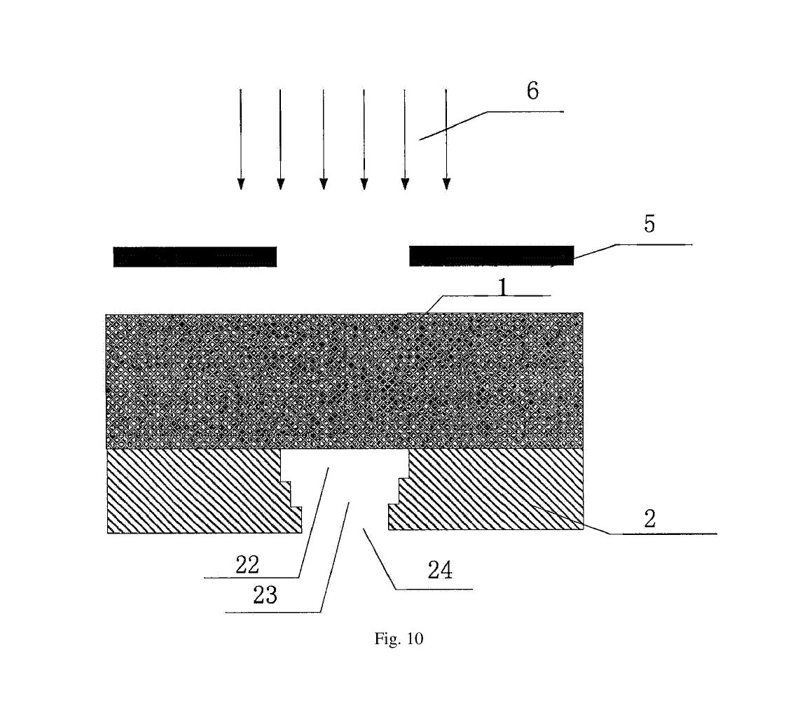

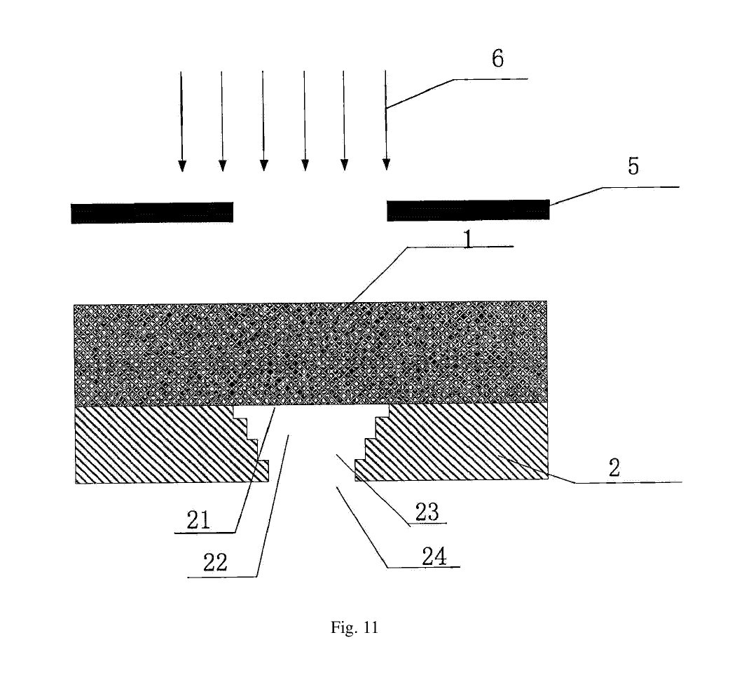

As illustrated in FIG. 9, after the step S2 is finished, a second exposing and developing process is performed on the side of the screen 1 on which no emulsion is applied. At this time, a mask plate 5 corresponding to the size of the third sub-opening 23 is used as the mask plate 5. At the same time, the size of the third sub-opening 23 can be precisely controlled by the corresponding mask plate 5.

In S32, the second sub-opening is formed.

After the step S31 is finished, a third exposing and developing process is performed on the side of the screen 1 on which no emulsion is applied. At this time, a mask plate 5 corresponding to the size of the second sub-opening 22 is used as the mask plate 5. At the same time, the size of the second sub-opening 22 can be precisely controlled by the corresponding mask plate 5.

In S33, the first sub-opening is formed.

After the step S32 is finished, a fourth exposing and developing process is performed on the side of the screen 1 on which no emulsion is applied. At this time, a mask plate 5 corresponding to the size of the first sub-opening 21 is used as the mask plate 5. At the same time, the size of the first sub-opening 21 can be precisely controlled by the corresponding mask plate 5.

In the above processes, by controlling the factors such as the size of the mask plate 5, precision of alignment, quantity of exposure, concentration of developer solution and developing period, the sizes of the respective sub-openings can be precisely controlled.

For example, positions of the respective mask plates 5 during exposure can be controlled so that the orthographic projections of center lines of the corresponding sub-opening patterns on the screen coincide with each other. Thus, the glass cement 4 is uniformly squeezed from both borders toward the center of the sub-opening, thereby avoiding an inhomogeneous phenomenon of more glass cement on one side and less glass cement on the other side.

For example, the size differences of patterns on the mask plates 5 corresponding to the sub-openings during exposure of the adjacent sub-openings can be controlled to be equal. Thus, the glass cements flowing downwards from both borders of the sub-openings are subjected to the same resistance, thereby maintaining a uniform downward movement.

For example, sizes of the respective mask plates 5 used during exposure can be controlled so that a difference between the horizontal dimension of the sub-opening pattern closest to the screen 1 and the horizontal dimension of the sub-opening pattern farthest away from the screen 1 is 50-200 um. Thus, it can be ensured that a sufficient amount of glass cement uniformly flows out of the fourth sub-opening 24.

For example, the thickness h of the sub-opening (for example, the fourth sub-opening 24) farthest away from the screen 1 in a direction perpendicular to the screen 1 can be controlled to be 2-10 um. Since the fourth sub-opening 24 is subjected to frequent impacts by the glass cement during the printing process and is inclined to be damaged or deformed, the above-defined thickness h can ensure its service life and effect.

It should be understood that the above-described patterning process of forming the respective sub-openings can be performed only on a side on which the emulsion is not applied. It is feasible to begin the patterning process from the fourth sub-opening 24 (i.e., the sub-opening have the smallest opening size) farthest away from the screen, which will not be described in further detail here.

It can be appreciated that the above embodiments are merely exemplary embodiments employed for the purpose of illustrating the principles of the present invention, but the present invention is not limited thereto. It will be apparent to those skilled in the art that various changes and modifications can be made without departing from the spirit and the essence of the present invention and are considered to be within the protection scope of the present invention.

1. A screen plate, comprising a screen and a pattern layer on a side of the screen, the pattern layer comprising at least one opening configured to form a pattern; the opening having a horizontal dimension which gradually decreases in a vertical direction from a side close to the screen to a side away from the screen.

2. The screen plate according to claim 1, wherein the opening comprises at least two sub-openings, and the respective sub-openings have horizontal dimensions gradually decreasing in turn along the vertical direction from the side close to the screen to the side away from the screen.

3. The screen plate according to claim 2, wherein orthographic projections of center lines of the sub-openings on the screen coincide with each other.

4. The screen plate according to claim 2, wherein differences in the horizontal dimensions of the sub-openings which are adjacent to each other in the vertical direction are equal.

5. The screen plate according to claim 2, wherein a difference between the horizontal dimension of the sub-opening closest to the screen and the horizontal dimension of the sub-opening farthest away from the screen is 50-200 um.

6. The screen plate according to claim 2, wherein a thickness of the sub-opening farthest away from the screen in a direction perpendicular to the screen is 2-10 um.

7. The screen plate according to claim 6, wherein the thickness of the sub-opening farthest away from the screen in the direction perpendicular to the screen is 4-7 um.

8. A manufacturing method of a screen plate, comprising the steps of:
applying a photoresist on a side of the screen;
exposing the side of the screen applied with the photoresist to light, forming a pattern of a sub-opening farthest away from the screen by developing, and then, exposing and developing at least once at a side of the screen opposite to the side applied with the photoresist so as to form at least one sub-opening; wherein the thus-formed sub-opening has a horizontal dimension gradually decreasing in turn in a vertical direction from a side close to the screen to a side away from the screen;
or,
exposing and developing at least twice at a side of the screen opposite to the side applied with the photoresist, so as to form at least two sub-openings; wherein the thus-formed sub-openings have horizontal dimensions gradually decreasing in turn in a vertical direction from a side close to the screen to a side away from the screen.

9. The manufacturing method of a screen plate according to claim 8, wherein positions of the respective mask plates used during exposure are controlled so that orthographic projections of center lines of the sub-opening patterns, which correspond to the respective mask plates, on the screen coincide with each other.

10. The manufacturing method of a screen plate according to claim 8, wherein sizes of the respective mask plates used during exposure are controlled so that differences in the horizontal dimensions of the adjacent sub-opening patterns among the respective sub-opening patterns which correspond to the respective mask plates are equal.

11. The manufacturing method of a screen plate according to claim 8, wherein sizes of the respective mask plates used during exposure are controlled so that a difference between the horizontal dimension of the sub-opening pattern closest to the screen 1 and the horizontal dimension of the sub-opening pattern farthest away from the screen 1 is 50-200 um.
